(19) United States
(12) Patent Application Publication
(10) Pub. No.: US 2016/0355727 A1
(43) Pub. Date: Dec. 8, 2016

(54) NANO-PROPPANTS FOR FRACTURE CONDUCTIVITY

(71) Applicant: THE UNIVERSITY OF KANSAS, LAWRENCE, KS (US)

(72) Inventor: REZA BARATI GHAHFAROKHI, LAWRENCE, KS (US)

(21) Appl. No.: 15/173,111

(22) Filed: Jun. 3, 2016

Related U.S. Application Data
(60) Provisional application No. 62/171,648, filed on Jun. 5, 2015.

(51) Int. Cl. C09K 8/80; C09K 8/66; E21B 33/12; E21B 43/267; E21B 43/26; C09K 8/68; C09K 8/90

(52) U.S. Cl. CPC C09K 8/80; C09K 8/685; C09K 8/665; C09K 8/90; E21B 43/267; E21B 43/26; E21B 33/12; C09K 2208/10

(57) ABSTRACT

Methods of hydraulic fracturing are disclosed. One method of hydraulic fracturing which is performed on a geologic stratum includes using a nano-proppant dominantly formed of particles having an average diameter of less than 1 μm dispersed in a fracturing fluid. A material for use in hydraulic fracturing may include a fracturing fluid and a nano-proppant dominantly formed of particles having an average diameter of less than 1 μm dispersed in the fracturing fluid.

### BACKGROUND

Field

The presently disclosed instrumentalities pertain to the use of proppants in the hydraulic fracturing of wells, which is done to increase production rates from naturally occurring oil and gas deposits in the Earth's crust.

Description of the Related Art¹ ¹ Citations in this discussion are to documents cited in the references section, infra.

Hydraulic fracturing is a well-known method for stimulating production from wells. As reported in U.S. Pat. No. 3,664,426, the process of hydraulic fracturing involves injecting fluids having a propping agent suspended therein at a pressure and rate of flow sufficient to fracture the formation. The injection continues until a sufficient amount of propping agent is deposited into the formation to hold the fracture open. The resulting fracture provides a zone of increased permeability and presents an increased surface area into which the surrounding formation can flow. Hydraulic fracturing is currently utilized to increase productivity from ultra-tight shale oil and shale gas reservoirs, for example, as described in U.S. Pat. No. 9,152,745 to Glinsky.

Hydraulic fracturing increases the hydrocarbon production from shale plays by connecting the already existing fissures and fractures and generating new small fissures. It is believed to dilate the already existing systems of small fissures and fractures which are initially filled with calcite, quartz or other minerals. Large surface areas and sustainable production may be caused by the large fracture networks created by the dilation of filled fractures or dissolution of fracture filling minerals. (Jaripatke et al., 2010). Current practices in tight shale plays having very low permeability and high brittleness prefer the use of linear gels, waterfracs, slick-water and hybrid fluids of increased Newtonian characteristics. These fracturing fluids are comparatively less viscous and aid in creating fractures with smaller width and longer fracture length. This helps to interconnect a network of created and natural fractures, generating a larger stimulated reservoir volume. Thus, fracturing jobs in tight shale plays tend to generate or extend a network of fractures while a bi-wing fracture is typically generated in conventional reservoirs. (Jaripatke et al., 2010).

It has been unappreciated in the art the extent to which fracturing of tight shale plays tends to generate or extend a network of fractures, as compared to a bi-wing fracture that is typically generated in conventional reservoirs of higher permeability. This network of fractures includes a large network of micro-fractures that open during the injection of fracturing fluids. These micro fractures tend to close and seal because conventional proppants do not penetrate the openings into these micro-fractures. In particular, proppants with different mesh sizes of 20/40, 30/50, 40/70, 70/140 and 80/200 with grain diameters ranging from 0.033 inch (0.8382 mm) to 0.0041 inch (104.14 μm) have been used during hydraulic fracturing of tight shale formations. These proppants are large enough to create conductivity in the larger generated or existing fractures, but they are not small enough to penetrate into the existing or generated micro-fractures. This causes the closure of micro-fractures at the end of a fracturing job thus reduction in the length and conductivity of the complex fracture network. This reduction of the fracture network extension reduces production from tight shale formations.

While not generally used in hydraulic fracturing applications, silica nanoparticles have been used successfully in drilling fluids to decrease water invasion into shale formations (Cai et al., 2012; Ozyildrim & Zgetosky, 2010; Zou & Yang, 2006). Silica nanoparticles are very stable and do not coagulate at pH values above 8. (Zou & Yang, 2006) Several research groups have demonstrated the capability of silica nanoparticles in reducing the damage caused by fines migration (Habibi et al., 2011; Ahmadi et al., 2011).

### SUMMARY

The presently disclosed instrumentalities overcome the problems outlined above and advance the art by providing proppants that are suitable for use in maintaining open micro-fractures resulting from hydraulic fracturing. While a very high conductivity is not required for very low permeability formations, an open fracture or micro-fracture performs significantly better than a collapsed fracture.

According to one embodiment, during fluid injection into the reservoir during hydraulic fracturing, the opening of the natural fractures and the pressure applied inside them decreases as the distance increases from the point of injection. Injecting nano-sized particles, followed by the conventionally used larger proppants, helps to sequentially fill the widened natural fractures, allowing deeper percolation of nano-proppants, thus propping more of the fracture length. This increases the seepage area thereby enhancing well productivity.

As used herein, a “nano-proppant” is a material having particles with an average particle diameter less than 1000 nm (1 μm) sufficient compressive strength to support fractures by preventing collapse of fractures a hydraulic fracturing application. The nano-proppant may be, for example, fly ash or any other silica or other types of nanoparticles that can withstand stress in the intended environment of use and have a generally spherical shape. A nano-proppant is “dominantly” formed of particles having a generally spherical shape if the spherical particles form a majority of the weight of the nano-proppant.

In various aspects of what is disclosed, increasing the effective conductivity of the hydraulic fractures propagated in tight oil or gas plays by improving the type and placement of proppants may prevent the collapse of already existing micro and nano-sized natural fractures which are opened up during injection. The proppants may also prevent the collapse of the fissures that are generated during the injection after the injection is stopped. The production of oil and/or gas from the formation is advantageously improved by reducing skin effects otherwise resulting from fluid loss into the formation, and by improving the total fracture conductivity.

In various aspects of what is described, the nano-proppant may be selected for entry into microfractures within low permeability producing reservoir rock. Thus, the average particle diameter may be, for example, less than 800 nm such as an average particle diameter ranging from 100 nm to 800 nm. Alternatively, the nano-proppant may have an average particle diameter ranging from 100 nm to 300 nm. The nano-proppant may be selected, for example, as Class C or Class F fly ash.

The nano-proppant may be combined with hydraulic fracturing fluids for control of fluid loss according to design parameters of a particular hydraulic fracturing process. The hydraulic fracturing fluid may be, for example, a linear gel, a waterfrac fluid, a slick-water fluid, a cross-linked gel, or a hybrid fluid combining the characteristics of one or more of these fluids.

The foregoing aspects may be particularly enhanced if small proppants are added to the injected fluid before addition of larger proppants. Use of nano-proppants prior to larger proppants may prevent fluid loss into the formation and increase the total extended length of the fracture network by propagating longer micro-fractures. The conductivity of those fissures and micro-sized fractures is consequently increased.

### BRIEF DESCRIPTION OF THE DRAWINGS

FIG. 1 shows a well that has drilled through geologic strata into a producing zone, such as an oil shale or a tight gas reservoir, where hydraulic fracturing is being used to stimulate production from the producing zone;

FIG. 2 shows proppants and nano-proppants distributed in fractures and micro-fractures, respectively, of the producing zone as a result of hydraulic fracturing;

FIG. 3 is a process schematic of the hydraulic fracturing process;

FIG. 4A is a tunneling electron micrograph (TEM image) of a substantially spherical nanoparticle of Class C fly ash, and FIG. 4B is a TEM image of a substantially spherical nanoparticle of Class F fly ash;

FIG. 5 is a bar graph showing average nano-hardness for each tested fly ash specimen, comparing Class C fly ash to Class F fly ash;

FIG. 6 is a bar graph showing average reduced elastic modulus for each tested specimen, comparing Class C fly ash to Class F fly ash;

FIG. 7 is a bar graph comparing fluid loss volumes obtained for different tests utilizing different hydraulic fracturing fluids;

FIG. 8 is a bar graph comparing fluid loss coefficients obtained for different hydraulic fracturing fluids;

FIG. 9 shows a core with a filter cake produced by use of a hydraulic fracturing fluid including HPG gel and fly ash;

FIG. 10 shows a core with a filter cake produced by use of a hydraulic fracturing fluid including fly ash in 2% KCl.

### DETAILED DESCRIPTION OF THE PREFERRED EMBODIMENTS

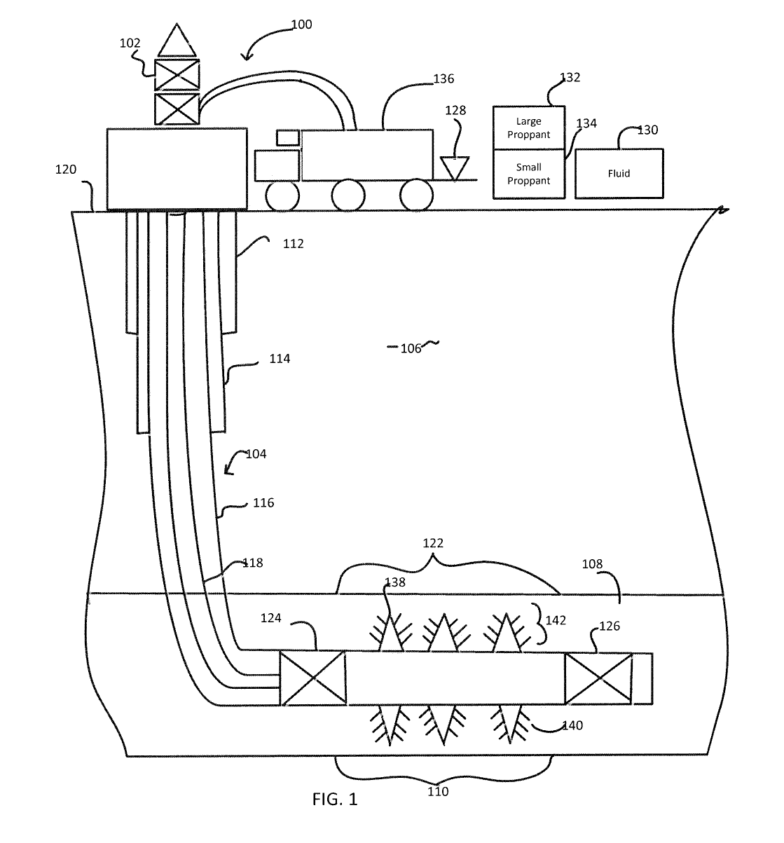

FIG. 1 shows a wellsite 100 with a well 102 undergoing a process of hydraulic fracturing. As shown in FIG. 1, a cased hole 104 penetrates geologic strata 106 to arrive at producing formation 108. The cased hole has been directoinally drilled by processes known to the art, in order to provide a substantially horizontal section 110. While not shown to scale, the cased hole 104 includes surface casing 112, one or more intermediate casings 114 and a final casing 116. Cement (not shown) is used to seal the respective casings 112-116 and isolate different zones within the geologic strata 106. There may be any number of intermediate strings 114.

As shown in FIG. 1, a drill pipe or tubing 118 extends from the surface 120 to a perforated region 122 of producing formation 108 that is isolated by packers 124, 126. A hopper 128 is used to mix fluid 130 on demand with large proppant 132 and small proppant 134. One or more pumping units 136 inject this mixture into tubing 118 at sufficient pressures to produce fractures 138, 140, each with a network of microfractures 142. The large proppant 132 fills the larger fractures 138, 140, and the small proppant fills the microfractures 142, such that the fractures 138, 140 and microfractures 142 remain open even after the pumping unit 136 has ceased injecting the fluid/proppant mixture into producing formation 108. The producing formation 108 may be any type of producing formation, but is a shale as illustrated in FIG. 1.

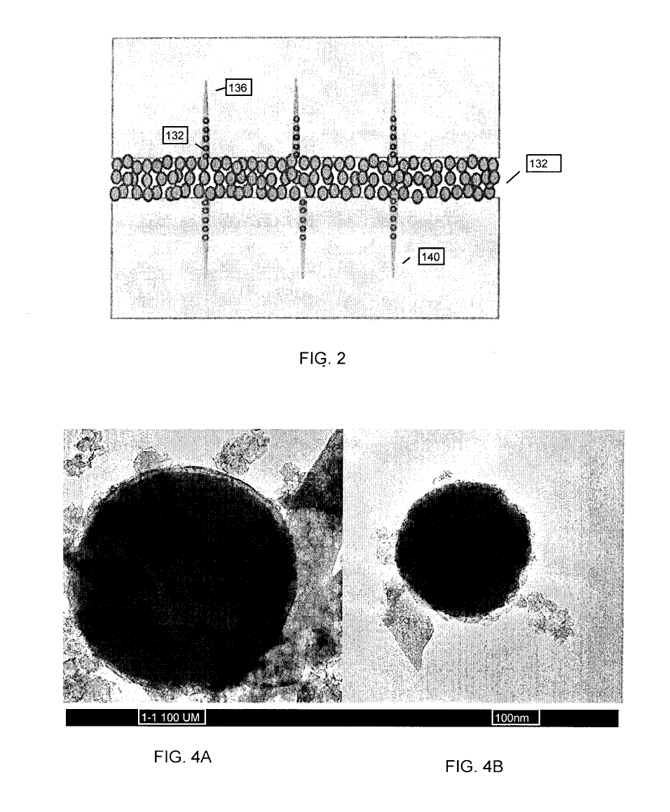

FIG. 2 provides additional detail with respect to fracture 138 as shown in FIG. 1. Large proppant 132 fills a primary fracture 200 communicating with perforation 202, which is formed through casing 116 by use of a shaped charge as is known in the art. Due to the brittleness of the shale constituting producing formation 108, a network of micro-fractures 204, 206 has formed; however, the mouths 208, 210 are too small to permit entry of large proppant 132. Thus, small proppant 134 fills the micro-fractures 204, 206.

The large proppant 132 is of a size conventionally used in hydraulic fracturing of shales. The proppant may be, for example, sand or ceramic with mesh sizes of 20/40, 30/50, 40/70, 70/140 and 80/200. The grain diameters generally range from 0.033 inch (0.8382 mm) to 0.0041 inch (104.14 μm). The small proppant 134 is preferably smaller than the large proppant, and nano-scale proppant is particularly preferred.

Fly ash provides a suitable form of small proppant 134. After the coal burns, the heavier ash particles fall to the bottom of the burning chamber and the lighter ash particles are carried away with the exhaust gas. The latter is known as fly ash and the former is known as bottom ash. Before being expelled into the atmosphere, the fly ash particles are removed and collected by electrostatic precipitators (Ladwig, 2010). Fly ash particles are generally spherical in shape, as the particles solidify rapidly while being suspended in the exhaust gas (Snellings et al., 2012). Class F fly ash contains less than 7% lime (CaO), as compared with Class C fly ash which contains more than 20% lime and undergoes a self-cementing reaction. For this reason, use of Class F fly ash is preferred over Class C, although the use of Class C ash is not precluded.

More particularly, the chemical properties of fly ash are largely influenced by the chemical content of the coal burnt. The two classes of fly ash are defined by ASTM C618: Class C fly ash and Class F fly ash. Class F fly ash is produced when the harder, older anthracite and bituminous coal is burnt. Class C fly ash is produced from the burning of younger lignite or sub-bituminous coal. The main difference between these classes is the amount of calcium, silica, alumina, and iron content in the ash (ASTM C618-08, 2008). Fly ash is a heterogeneous material. SiO₂, Al₂O₃, Fe₂O₃ and CaO are the main chemical components present in fly ash. Other components like MgO, TiO₂, arsenic, etc. are also present.

TABLE 1
Constituents and their typical compositions in Class F fly ash

| Constituent | Typical Composition ranges |
|---|---|
| SiO₂ | (40-60)% |
| Al₂O₃ | (18-31)% |
| Fe₂O₃ | (5-25)% |
| CaO | (1-6)% |
| MgO | (1-2)% |
| TiO₂ | (1-2)% |
| Inorganic arsenic | (16-210) ppm |

Fly ash from power plants is considered a waste product. This cheap waste material includes nano-particles of silicon oxide, calcium oxide and aluminum oxide. Application of fly ash nanoparticles as fluid loss minimizing additives and nano-proppants for tight and ultra-tight reservoir rocks is suitable according to most embodiments in a range from 0/1 lb to 5 lb/gal. This concentration may be ramped up or increased to even greater amounts as the job progresses by design. The hydraulic fracturing fluid may be any type of such fluid commonly in use in the industry. By way of example, a crosslinked fluid typically uses guar material in a range from 1000 to 10,000 ppm, with borax as a crosslinker in a range from 100 to 5000 ppm.

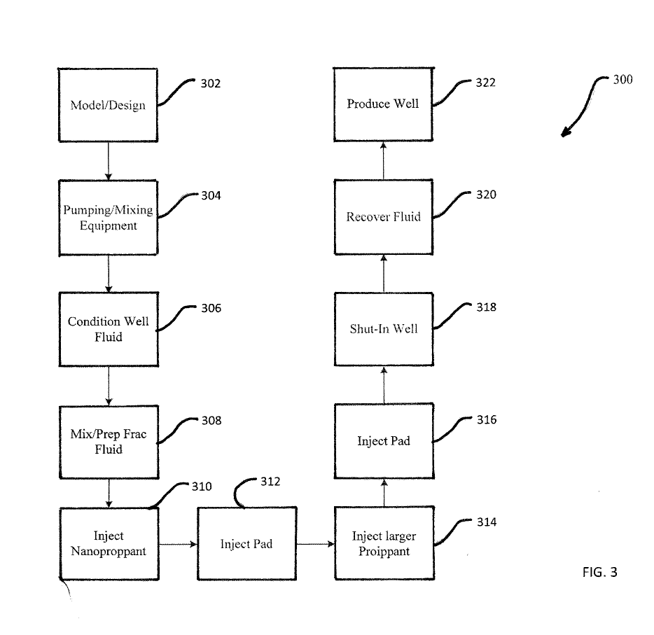

FIG. 3 shows a schematic of a hydraulic fracturing process 300 that may be conducted utilizing the system of FIG. 1. The process for a particular well is modeled 302 for design purposes to assess such parameters as pressure limits, flow rates, fluid content, proppant content, perforation number and type, and geologic horizon. The modeling processes are known to the art and are available on commercial order, except insofar as they are modified as described herein to include the use of nano-proppants. For practical purposes, the use of nano-proppants may be considered to be a substitute for the normal volume of larger proppant currently in use. For example, hydraulic fracturing processes may be modeled using such commercially available software as FRACPRO™ by Carbo of Houston, Texas, STIMPLAN™ by NST Technologies of Tulsa, Okla., and MFRAC™ by Baker Hughes of Houston, Tex. With these parameters in mind, the necessary mixing and pumping equipment are delivered to a wellsite and connected 304 in a manner that is capable of meeting the design parameters for the hydraulic fracturing process, as established in step 302. This may include, for example, connecting pump truck in tandem and providing a hopper system with sufficient capacity to mix proppant with fluid on demand according to the process needs. As needed, fluid inside the sell may be conditioned 306, for example, by circulation to substitute drilling mud with salt water. The fluid for use in hydraulic fracturing is mixed 308 according to design parameters, for example, to provide the fluid for a crosslinked polymer, linear gel, waterfrac, slick-water or hybrid fracking fluid. A pad of fluid is injected 310 to facilitate fracturing and condoning of the wellbore. Nano-proppant material is next mixed to substantial homogeneity with fluid from step 308 and injected 311 into the well. A pad of additional fluid without proppant is next optionally injected 312 to provide separation between proppants of different sizes. The larger proppant is then mixed to substantial homogeneity and injected 314. This last injection of proppant may be followed by injecting 316 a second pad to displace proppant in the wellbore into fractures.

After injection of all materials is complete, the well is shut-in 318 to allow fluid loss into the formation as the hydraulically induced fractures close around the injected proppant. The well may be optionally swabbed or flowed to recover 320 a portion of the injected fluid, after which the well has been stimulated for increased production 322.

It will be appreciated that fluids of different compositions may be mixed in step 308, each such fluid being allocable to injection of nano-proppant 311 or injection of larger proppant 314. Moreover, while FIG. 3 shows two steps of proppant injection 311, 314, there may be any number of proppant injections steps each allocated to a different size proppant. In this circumstance, the proppant size preferably increases with each injection step.

### WORKING EXAMPLES

Fly ash particles were tested for their size, nano-hardness, reduced elastic modulus, and fluid loss prevention capabilities as well as for their induced fracture conductivity.

All tests supported the application of fly ash nanoparticles as fluid loss additives and nano-proppants.

In summary of the results to follow, fly ash nanoparticles were found to have the following properties:
1) High sphericity as observed from the TEM images which makes them ideal candidates to be used as proppants
2) High mechanical strength and reduced elastic modulus which, as observed from the nano-indentation experiments, would enable them to withstand the stresses that proppants are likely to be subjected to in most shale formations
3) Found to be effective fluid loss additives when tested with static fluid loss tests
4) Formed a conductive proppant pack when used as proppants in the long term fracture conductivity tests

The results of this study showed that fly ash nanoparticles may be used as both fluid loss additives as well as nano-proppants for hydraulic fracturing of tight and ultra-tight formations. These particles will prevent fluid loss during the propagation of hydraulic fractures while they pack the system of micro-fractures induced by propagation of hydraulic fractures. The fluid loss prevention capability of such nanoparticles can also be applied to prevent mud loss during drilling of wells in tight and ultra-tight formations.

### Nomenclature

The following terms, defined below, are used in the examples:
C_{W}=Wall-building fluid loss coefficient, ft/min ½
Sₚ=Volume leaked off while the filter cake is being formed (Spurt volume), mL
t=Time (minutes)
k=Permeability of the proppant pack (Darcy's)
μ=Viscosity (cp)
L=Distance between the pressure ports (ft)
q=Flow rate (STB/D)
w=Cell width (ft)
w_{f}=Pack width (ft)
Δp=Pressure difference (psi)
K_{wf}=Conductivity (mD.ft)
F_{cd}=Dimensionless Fracture Conductivity
K=Formation permeability (mD)
X_{f}=Fracture half-length (ft)

### Materials

Materials utilized in the working examples are from sources as described and characterized below:

Fly Ash. Alliant Energy of Madison Wisconsin provided two samples of fly; Class ‘C’ and Class ‘F’, with slight differences in their constituents and compositions. After being washed with 2% KCl, the samples were imaged using a Transmission Electron Microscope (TEM) followed by nano-indentation tests to measure their ability to withstand compressive stress. Class F fly ash nanoparticles were used as fluid loss additives in the fluid loss tests and as nano-proppants for the conductivity tests.

Core Materials. Scioto sandstone core wafers were used for the fracture conductivity tests. They were supplied by Kocurek Industries of Caldwell, Texas. The cores were cylindrically shaped with high precision, i.e. the dimensions were within 0.03″ of the cell body dimensions. The upper core dimensions were calculated to be 7″ in length, 1.44″ in width, and 0.70″ in thickness, whereas the bottom core dimensions were 7.25″ in length, 1.8″ in width, and 0.625″ in thickness. Porosity and gas permeability of the Scioto sandstone cores were reported to be 12% and 0.01-0.1 mD respectively. The core samples used for fluid loss tests where Indiana limestone cores with brine permeability ranging between 1-10 mD. The dimensions were approximately 1″, both in length and diameter.

Guar Products. Hydroxypropyl guar (HPG) gum blend was obtained as Jaguar® 415, a trademark of Rhodia in Paris, France. Lot#H0904166E was used for all the experiments reported herein. Jaguar® 415 is a high viscosity chemically modified polysaccharide, which disperses readily and then hydrates on its own, to yield a smooth and viscous solution.

Borate Cross-Linker. Sodium tetraborate decahydrate was obtained from J.T Chemical Co. of Philipsburg, N.J., Lot No. 110M0107V. This material was used as the source of borate ions in cross-linking guar polymer to generate guar gel.

Potassium Chloride Solution. All solutions reported below were made in 2% KCl solution as the base fluid. 20 mg of potassium chloride (KCl) was obtained from Sigma Aldrich, identified as P code 1001404659, Lot# SLBH1238V. The KCl was added to 980 g of water purified by reverse osmosis and stirred using a magnetic stirrer to obtain a homogeneous 2% KCl solution. Density of the resulting brine was measured as 1.0105 g/cm3 and viscosity was 0.95 CP at 25° C.

Guar Solutions and Fly Ash Solution Preparation. Two solutions were prepared using guar. One solution contained class F fly ash. The other solution was used as a control and did not contain fly ash. Guar solutions of 5000 ppm in the liquid phase were prepared by carefully measuring out 0.75 g of guar powder (Jaguar® 415.) and 150 g of 2% KCl solution. During the addition of the guar powder, the brine solution was stirred rapidly at 600 rpm using a magnetic stir bar inside a 500 ml beaker. Guar powder was added to the shoulder of the vortex while the solution was stirred in order to prevent clumping. 5 minutes following the addition of guar, the stirring rate was lowered to 400 rpm and it was allowed to stir for about an hour. 6 ml of the solution was removed to make the volume 144 ml. After the solution was prepared, 45 ml of 2% KCl was added along with 45 ml of borate cross linker, to make up a final volume of 234 ml cross linked HPG gel. For gaur samples containing fly ash, fly ash quantity required to form a final 1% concentration (by wt.) of fly ash in the 234 ml of final solution was weighed and added to the solution along with the 2% KCl solution. For the fly ash sample without guar, fly ash was simply added to 2% KCl, to yield a 1% solution by weight, in order to produce another control system. Please note that the class F sample, which showed more promising results with conductivity tests was used for the fluid loss tests.

The volume of each fluid and their respective combinations used in each experiment is given below
Control Solution: 45 ml 2% KCL+144 ml HPG(5000 ppm)+45 ml Borate cross linker, the final concentration of HPG in the solution was 3077 ppm.
Fly Ash With Cross-Linked Guar Solution: 2.34 g of fly ash in 42.66 ml of 2% KCL+144 ml HPG (5000 ppm)+45 ml Borate cross linker, the final concentration of HPG in the solution was 3077 ppm.
Fly Ash Solution: 2.34 g of fly ash added to 231.66 ml of 2% KCl solution.

### EXAMPLE 1

### Core Saturation and Porosity Measurement

After measuring the length and diameters of core plugs to establish bulk volume by calculation, the cores were dried in a 70° C. oven until they reached a constant weight. Cores were evacuated for 30 minutes using a desiccator connected to a vacuum pump. The valve to the vacuum pump was closed next, and inlet valve was opened to allow the flow of 2% KCl. Inlet lines were filled with the saturation fluid before opening the inlet valve. Porosity was calculated by weighing the core sample before and after its saturation with 2% KCl brine. Pore volume as a percentage of bulk volume was calculated using the measured density of 2% w/w KCl.

### EXAMPLE 2

### Permeability Measurement

Permeability of the cores was determined utilizing the technique and apparatus previously published by Bose et al., 2014 shows the apparatus used to measure the permeability of the cores. An ISCO pump filled with SOLTROL-130 was connected to a transfer cylinder filled with SOLTROL-130 and 2% w/w KCl. A Hassler-type core holder supported by a hydraulic pump, in order to apply confining pressure, was connected to the transfer cylinders. A differential pressure transmitter (Honeywell) connected to the inlet and outlet of the core and the tubing connecting the transmitter to the flow line was filled with SOLTROL-130. The whole setup was placed in a constant temperature chamber. This setup was used for the permeability measurement of the cores used for fluid loss tests. Pressure drop, temperature of cabinet, viscosity and the permeability (calculated using Darcy's law) were recorded during each test.

### EXAMPLE 3

### Transmission Electron Microscopy (TEM)

Fly ash samples were prepared by suspending the particles in ethanol and agitating in an ultrasonic bath for 15 minutes. 5 μl of the fly ash particle sample was placed onto copper mesh grid with a lacey carbon film. The wet grids were allowed to air-dry for several minutes before they were examined under a TEM. The particle size and morphology of the fly ash particles were examined by using a FEI Technai F20 XT field emission transmission electron microscope at an electron acceleration voltage of 200 kV. The High resolution TEM images were captured using a standardized, normative electron dose and a constant defocus value from the carbon-coated grid.

TEM images were obtained to measure the size of different samples of nanoparticles. Round shape nanoparticles between 100 nm and 800 nm were observed in addition to some residue that remained, despite washing the particles with 2% KCl and separating the lighter particles using a centrifuge, prior to imaging them. The images in FIGS. 4A and 4B show TEM images captured from two different types of fly ash particles selected from two different power plants. FIG. 4A shows a nanoparticle within the 200-800 nm range obtained from the sample of Class C fly ash. FIG. 4B shows a nanoparticle from the sample of Class F fly ash with particle sizes within 100-300 nm range. Such nanoparticle sizes are suitable to be used as fluid loss additives for reservoir rocks with average pore diameters of 3 μm and 1 μm, respectively. These are typically rocks of higher porosity for which fluid loss prevention is required.

The sphericity of the proppant particles has a direct relation to the conductivity of the fracture propped by the respective proppants. Particles with higher sphericity result in better conductivity of the fracture. Most of the particles in both the Class C and Class F fly ash were found to be spherical in shape, which shows the potential for creating a highly conductive fracture when placed inside the micro fractures which are naturally present. Further modifications have to be done in the future to cleanup fly ash particles from residues.

### EXAMPLE 4

### Nano-Indentation

The testing instrument used for performing nano-indentation tests was a Nano-mechanical Test System (manufactured by Hysitron, Inc., USA). The Nano-mechanical Test System is a high-resolution nano-mechanical test instrument that performs nano-scale quasi-static indentation by applying a force to an indenter tip while measuring tip displacement into the specimen. During indentation, the applied load and tip displacement are continuously controlled and measured, creating a load-displacement curve for each indent. In order to conduct nano-indentation and particle size analysis, the particle specimens were sparsely dusted onto a steel disk surface with strong and fast curing adhesive. Table 2 below summarizes the test conditions and parameters used in the nano-hardness and modulus tests. To obtain the nano-hardness and reduced elastic modulus values, 10 indents, were made onto 10 particles. All indents and images of particles were performed through in-situ SPM imaging. Class C fly ash was tested under a load of 70 μN while Class F was tested under a load of 50 μN. The loads were selected to reach contact depths at maximum of 50 nm, to prevent from indenting too deep into the smaller particles.

TABLE 2
Nano-hardness and Modulus Testing Conditions and Parameters

| | |
|---|---|
| Specimens | 2 Kinds of Fly Ash Powder Specimens |
| Test instrument | TriboIndenter |
| Indenter Probe Tip | Diamond Berkovich indenter tip |
| Indentation Loads | 50, 70 μN |
| Temperature | 70° F. |
| Humidity | 16% RH |
| Environment | Ambient air |

Nano-scale quasi-static indentation was performed on both samples of fly ash particles by applying a force to an indenter tip while measuring tip displacement into the specimen. From the load-displacement curve, nano-hardness and reduced elastic modulus values were determined by applying the Oliver and Pharr method using a pre-calibrated indenter tip area function and a pre-determined machine compliance value (Oliver et al., 2003).

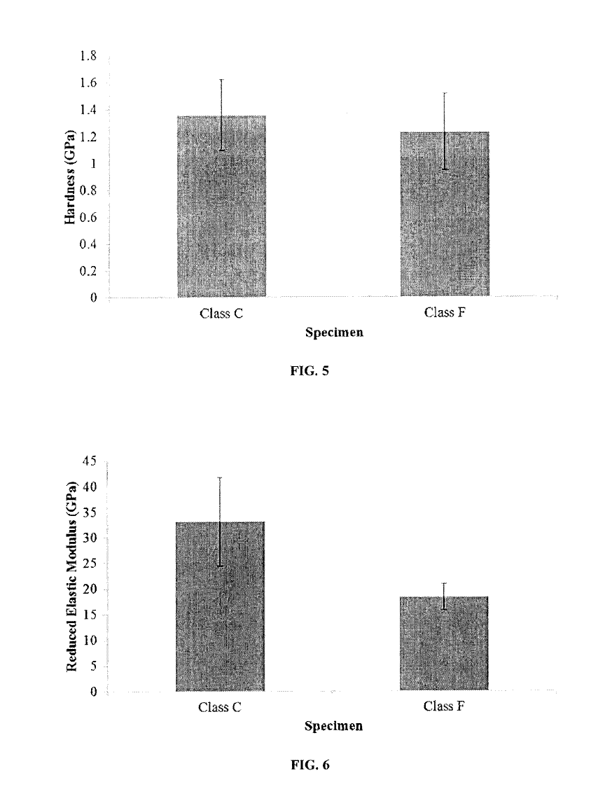

FIGS. 5 and 6 show the average nano-hardness and reduced elastic modulus, respectively, for all tested specimens. Class C fly ash nanoparticles showed higher hardness and modulus of 1.36 GPa and 33.10 GPa, respectively. Class F fly ash nanoparticles showed hardness and modulus of 1.23 GPa and 18.35 GPa, respectively.

The measurement of the average value of reduced elastic modulus provides information about the extent of deformation that can happen to the proppants when subjected to stress. The conductivity of the fracture is adversely affected when the proppants get compressed. An average reduced elastic modulus of 33 GPa for class C and 20 GPa for Class F fly ash shows the ability of the fly ash particles to withstand deformation.

The hardness of a material is the measure of how resistant the material is to permanent deformation under the effect of a compressive stress. It is very important that the nano-proppants placed inside the fractures are able to withstand the effective minimum stress usually encountered in the horizontal direction, and the absolute vertical stress which is a function of their depth under the surface. A hardness value of 1.3 GPa for class C and 1.2 GPa for class F translates to 1.8×10⁵ psi and 1.7×10⁵ psi, respectively, which implies that these nano-proppants can withstand more than the maximum stresses encountered in a typical shale formation.

### EXAMPLE 5

### API Static Fluid Loss Tests

API Static Fluid Loss tests utilized the system disclosed by Bose et al. (2014). A 1 inch by 1 inch core was placed inside a fluid loss cell. Fracturing fluid was placed on top of the core and 550 psi pressure was applied using nitrogen to conduct the fluid loss test. Leakage was prevented by O-ring seals and a rubber core holder in place, which prevented any possible overpass of the core. A nitrogen supply provided the pressure for the fluid loss and the back pressure (50 psi) required, thus eliminating any chance of water vaporizing in the outlet. Pressure was recorded at the inlet and the outlet, and temperature is recorded at the inlet and heat jacket. The fluid loss cell was placed inside a cabinet equipped with valves used to set the inlet and back pressure. Fluid loss volume was plotted versus square root of time during a 90-minute test utilizing the technique disclosed by Barati et al., 2014. Fluid loss tests were conducted for the different combinations of fluids mentioned above, including the Control Solution, Fly Ash With Cross-Linked Guar Solution, and Fly Ash Solution.

A standard procedure was developed to use a conductivity cell described by Bose et al. (2014) following API recommendations to measure fracture conductivity tests. Cores were sealed, dried, and saturated. They were weighed before and after saturation (with 2% KCl solution) for measuring the porosity. 3 lb/ft³ loading of proppants were used. The cores were placed inside the cell with a mixture of fly ash and 2% KCl in between them. The total volume of the 2% KCl solution used was maintained constant at 234 ml.

Immediately after the conductivity cell was assembled with the proppants and 2% KCl between the cores, a constant closure stress (500 psi) was applied on a top piston using a hydraulic press. The leak off fluid was collected. After the cores reached the proppants, the applied closure stress applied was raised to 2000 psi, and the cell was left overnight under the stress for 12 hours to simulate the shut in period after the fracturing. After the cell was left under the overburden stress for 12 hours, 2% KCl solution was flowed continuously in two directions: through the fracture width and through the cores successively for 24 hours to simulate fracture clean-up. At the end of the flow time, the lines were connected to a differential pressure transducer to read the pressure drop across the fracture. The part of the piston outside the cell was measured in each case and the fracture width was calculated with the pre knowledge of the dimensions of the cell and the pistons, as described by Bose et al, 2014. Making use of the Darcy's law of flow through porous media, the conductivity across the fracture length (proppant pack) was calculated according to Darcy's equation modified for calculating the conductivity of the proppant pack, i.e., Equation (1) below:

k=qμL/1.127 wΔp (1)

The fluid loss tests were conducted on Indian limestone (IL) core samples having a permeability range of 1-10 mD. This represents the higher permeability regions along a fracture where fluid loss prevention is required. The results obtained from the first experiment, where the borate cross linked 5000 ppm. The Control Solution of cross-linked HPG were compared with that of the second experiment utilizing the Fly Ash With Cross-Linked Guar Solution, and the third experiment utilizing the Fly Ash Solution. The final concentration of cross linked guar was made to 3077 ppm in the first two cases, and the total volume of fluid was maintained constant at 234 ml so that the results could be compared with each other to study the effect of the addition of fly ash.

The volume of each fluid and their respective combinations used in each experiment is given in Table 3 below. Table 3 summarizes all the core plugs used for API static fluid loss tests along with their porosity and permeability values. Permeability measurements using only 2% KCl were conducted before and after each test to measure the permeability of the core.

TABLE 3
List of core plugs used for API fluid loss
tests and their porosity and permeability

| Core name | Porosity (%) | Permeability (mD) |
|---|---|---|
| IL#15 | 5.3 | 4.53 |
| IL#16 | 5.49 | 4.7 |
| IL#8 | 5.76 | 6.8 |

Table 4 gives a summary of the fluids applied for fluid loss testing using different cores. Total fluid loss volume and fluid loss coefficients related to each test are also reported. Fluid loss coefficient (Cw) is calculated using the slope of the linear part of the fluid loss curve according to Equation (2).

V_{L}=2C_{w}√t+Sₚ (2)

TABLE 4
Summary of fluid properties, measured fluid loss volumes and
calculated fluid loss coefficients during a 90-minute API fluid loss test

| | | Total fluid | |
|---|---|---|---|
| Core | Fluid | loss volume, ml | Cw (ft/min^{1/2}) |
| IL#15 | 144 ml HPG + 45 ml | 6.93 | 0.0019 |
| | Borate + 45 ml 2% | | |
| | KCL | | |
| IL#16 | 144 ml HPG + 45 ml | 4.07 | 0.0015 |
| | Borate + 45 ml (fly | | |
| | ash + 2% KCl) | | |
| IL#8 | 150 ml 2% KCL + 2.34 g | 221.6 | 0.15 |
| | fly ash class F | | |

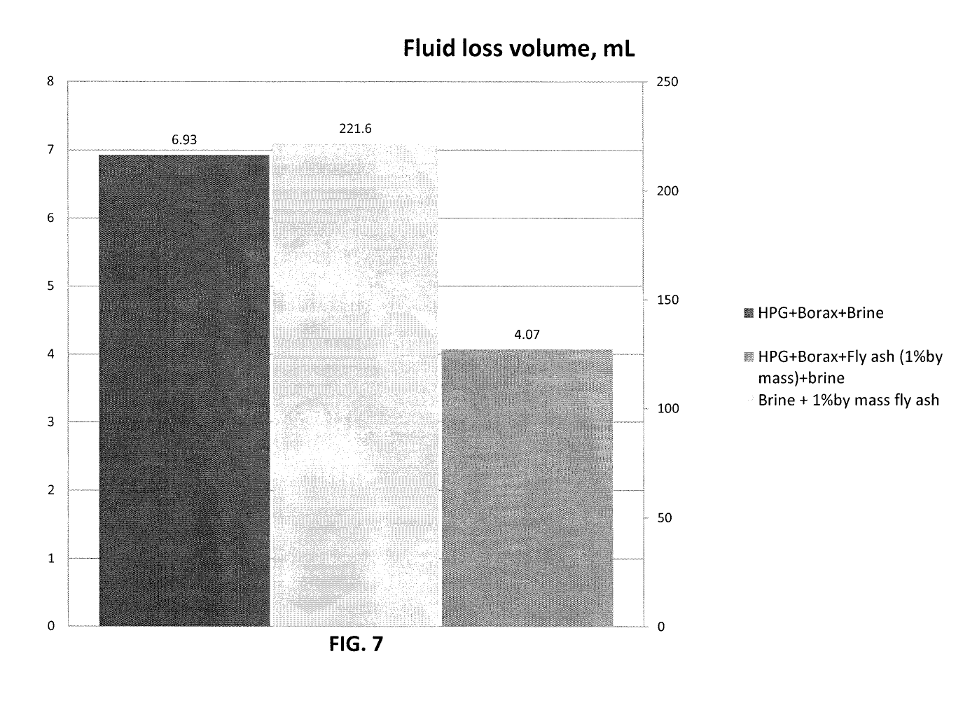

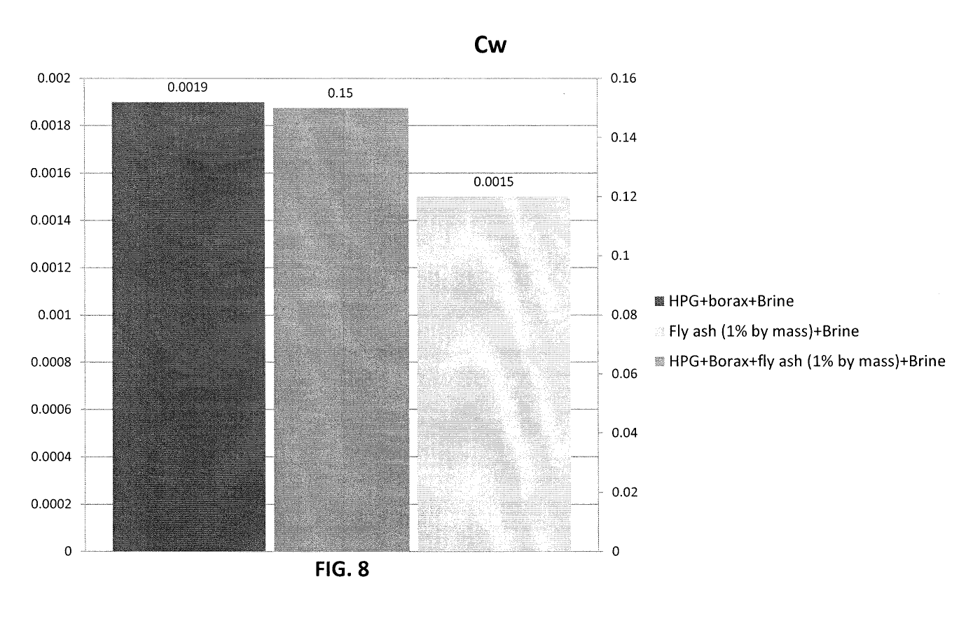

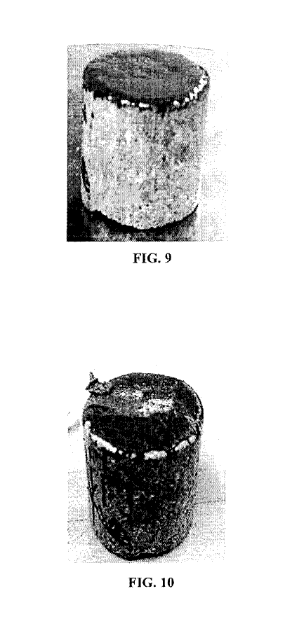

Fly ash nanoparticles performed as strong fluid loss control additives both by reducing the fluid loss coefficient and the total fluid loss volume, as shown in FIGS. 7 and 8. When used with just 2% KCl, fly ash particles tended to settle very quickly and non-uniformly. FIG. 10 shows that after the fluid loss, the filter cake that is formed using 1% fly ash solution in 2% KCl is not uniform. Even though there were no visible particles in the fluid that was lost, the filter cake that existed allowed the fluid to easily flow through, which resulted in a very high fluid loss volume. shows that with the addition of cross linked guar to the 2% KCl and Class F fly ash, a uniform filter cake was formed which apparently reduced the fluid loss. This can help explain the significant difference in fluid loss volumes that were observed between the experiments where fly ash was used with only 2% KCl and where fly ash was used with cross linked guar.

A significant reduction in the fluid loss volume and coefficient was observed when fly ash particles were added to the HPG gel solution compared to the case where there were not any fly ash particles in the solution. Fluid loss prevention capability of the fly ash nanoparticles for higher permeability rocks will aid in the generation of longer fracture wings as well as in the extension of network of fractures during a hydraulic fracturing job. Reduction in the fluid loss volume caused by the fly ash nanoparticles will result in a cleaner fracture with higher fracture conductivity that can produce higher volumes of hydrocarbons.

### EXAMPLE 6

### Long Term Fracture Conductivity Tests

Long term fracture conductivity tests complying with the API recommended procedures were conducted using Scioto sandstone cores with permeability values of approximately 0.01 mD. Fly ash samples of class F were used as proppants between two core wafers placed under stress and fracture conductivity of this proppant pack was measured. Using a loading of fly ash that generated similar width to a 3 lbm/ft² proppant pack, fracture conductivity of 0.779 mD.ft was obtained for the Class F fly ash sample, which translates to a dimensionless fracture conductivity value of approximately 10.

Prats (1961) showed that a significant increase in production would not be caused because of an increase in the dimensionless conductivity beyond 10 or 20. This implies that the fly ash nanoparticles when used as nano-proppants would create a longer fracture which will contribute to hydrocarbon production. For the shale formations, where the formation permeability is usually very low, injection of fly ash ahead of commercial proppants is recommended to pack the network of micro-fractures.

### REFERENCES

The following documents are incorporated by reference to the same extent as though fully replicated herein:

“ASTM C618-08 Standard Specification for Coal Fly Ash and Raw or Calcined Natural Pozzolan for Use in Concrete”.

Ahmadi, M., Habibi, A., Pourafshary, P., & Ayatollahi, S. (2011). “Zeta Potential Investigation and Mathematical Modeling of Nanoparticles Deposited on the Rock Surface to Reduce Fine Migration”. SPE Middle East Oil and Gas Show and Conference. Manama, Bahrain.

Alliant Energy Material Safety Data Sheets for fly ash, 2005

Anna, L. O. (2009). “Geologic Assessment of Undiscovered Oil and Gas in the Powder River Basin Province, Wyoming and Montana”. U.S. Department of the Interior and U.S. Geological Survey.

Barati, R., Hutchins, R. D., Friedel, T., Ayoub, J. A., Dessinges, M., & England, K. W. (2009). “Fracture impact of yield stress and fracture-face damage on production with a three-phase 2D model”. SPE Production & Operations , 24(2).

Barati, R., Johnson, S. J., McCool, C. S., Green, D. W., Willhite, G. P., & Liang, J.-T. (2011, August 5). “Fracturing Fluid Cleanup by Controlled Release of Enzymes from Polyelectrolyte Complex Nanoparticles”. Journal of Applied Polymer Science, August 2011.121(3), 1292-1298.

Barati, R., Johnson, S. J., McCool, C. S., Green, D. W., Willhite, G. P., & Liang, J.-T. (2012). “Polyelectrolyte complex nanoparticles for protection and delayed release of enzymes in alkaline pH and at elevated temperature during hydraulic fracturing of oil wells”. Journal of Applied Polymer Science 126(2):587-92

Bose, Charles; Alshatti, Bader; Swartz, Levi; Gupta, Aadis; Barati, Reza (2014). “Dual Application of Polyelectrolyte Complex Nanoparticles as Enzyme Breaker Carriers and Fluid Loss Additives for Fracturing Fluids”. (2014). SPE/CSUR Unconventional Resources Conference Calgary, Alberta, Canada: Society of Petroleum Engineers.

Cai, J., Chenevert, M., Sharma, M., & Friedheim, J. (2012, March). “Decreasing Water Invasion Into Atoka Shale Using Nonmodified Silica Nanoparticles”. SPE Drilling and Completion.

Carboceramics. (n.d.). Retrieved from http://archive.carboceramics.com/English/tools/topical_ref/tr_conductivity.html

Chenevert, “Hydraulic Fracturing Method,” U.S. Pat. No. 3,664,426.

Glinsky, “Model Predicting Fracturing of Shale,” U.S. Pat. No. 9,152,745.

Ladwig, K (2010), “Comparison of coal combustion products to other common materials”—Chemical Characteristics, Electric Power Research Institute, Palo Alto, Calif.

Habibi, A., Ahmadi, M., Pourafshary, P., & Ayatollahi, S. (2011). “Reduction of Fine Migration by Nanofluids Injection, An Experimental Study”. SPE European Formation Damage Conference. Noordwijk.

Jaripatke, O., Grieser, B., & Chong, K. (2010). “A Review Of Successful Approach Towards Shale Play Stimulation In The Last Two Decades”—A Completions Road Map To Shale Play Development. SPE Deep Gas Conference and Exhibition. Manama, Bahrain.

Johnson, R., & Brown, T. (1993). “Large-Volume, High-Rate Stimulation Treatments in Horizontal Wells in the Niobrara Formation”, Silo Field, Laramie County, Wyoming. SPE Rocky Mountain Regional/Low Permeability Reservoirs Symposium. Denver.

Keshavarz, A., Badalyan, A., Carageorgos, T., Johnson, R., & Bedrikovetsky, P., (February, 2014). SPE 167757 “Stimulation of Unconventional Naturally Fractured Reservoirs by Graded Proppant Injection: Experimental Study and Mathematical Model” for presentation at the SPE/EAGE European Unconventional Conference and Exhibition held in Vienna, Austria, 25-27,2014.

Khanna, A., A. Keshawarz, et al. (2013). “Stimulation of the natural fracture system by graded proppant injection.”Journal of Petroleum Science and Engineering.

Oliver, W. C., G. M. Pharr (2003). “Measurement of hardness and elastic modulus by instrumented indentation: Advances in understanding and refinements to methodology”. Journal of Material Science Research

Ozyildrim, C., & Zgetosky, C. (2010). “Laboratory Investigation of Nanomaterials to Improve the Permeability and Strength of Concrete”. Charlottesville, Va.: Virginia Transportation Research Council.

Prats, M., “Effect of Vertical Fractures on Reservoir Behavior—Incompressible Fluid Case”, SPE Journal Volume 1, Number 2 pp105-118, 1961.

Snellings, R.; G., Mertens; J., Elsen (2012) “Supplementary cementitious materials”. Reviews in Mineralogy and Geochemistry 74: 211-278. doi:10.2138/rmg.2012.74.6

Sonnenberg, S. A. (2001). “Core Analysis and Unconventional Reservoirs”. Tight Oil From Shale Plays. Denver.

University of Kansas-Research & Graduate Studies. (n.d.). Retrieved from http://rgs.ku.edu/proposals/tuition_fees.shtml

Vincent, M. (2012, March). “The Next Opportunity to Improve Hydraulic-Fracture Stimulation”. JPT.

Zou, M., & Yang, D. (2006, May). “Nanoindentation of silica nanoparticles attached to a silicon substrate”. Tribology Letters, 22(2).

We claim:

1. In a method of hydraulic fracturing performed on a geologic strata, the improvement comprising:
using a nano-proppant dominantly formed of particles having an average diameter less than 1 p.m dispersed in a fracturing fluid.

2. The method of claim 1 wherein the step of using the nano-proppant precedes a step of injecting a larger proppant having an average grain size greater than 0.5 mm.

3. The method of claim 1, wherein the average particle diameter is less than 300 nm.

4. The method of claim 1, wherein the average particle diameter ranges from 100 nm to 800 nm.

5. The method of claim 1, wherein the average particle diameter ranges from 100 nm to 300 nm.

6. The method of claim 1, wherein the nano-proppant is fly ash.

7. The method of claim 1, wherein the nano-proppant is Class C fly ash.

8. The method of claim 1, wherein the nano-proppant is Class F fly ash.

9. The method of claim 1, wherein the fracturing fluid is a linear gel.

10. The method of claim 1, wherein the fracturing fluid is a waterfrac fluid.

11. The method of claim 1, wherein the fracturing fluid is a slick-water fluid.

12. The method of claim 1, wherein the fracturing fluid is a cross-linked gel.

13. A material for use in hydraulic fracturing, comprising:
a fracturing fluid; and
a nano-proppant dominantly formed of particles having an average diameter less than 1 μm dispersed in the fracturing fluid.

14. The material of claim 13, wherein the average particle diameter is less than 800 nm.

15. The material of claim 13, wherein the average particle diameter is less than 300

16. The material of claim 13, wherein the average particle diameter ranges from 100 nm to 800 nm.

17. The material of claim 13, wherein the average particle diameter ranges from 100 nm to 300 nm.

18. The material of claim 13, wherein the nano-proppant is fly ash.

19. The material of claim 13, wherein the nano-proppant is Class C fly ash.

20. The material of claim 1, wherein the nano-proppant is Class F fly ash.

21. The material of claim 1, wherein the fracturing fluid is a linear gel.

22. The material of claim 1, wherein the fracturing fluid is a waterfrac fluid.

23. The material of claim 1, wherein the fracturing fluid is a slick-water fluid.

24. The material of claim 1, wherein the fracturing fluid is a cross-linked gel.
